(19) United States
(12) Patent Application Publication
(10) Pub. No.: US 2026/0253855 A1
(43) Pub. Date: Aug. 27, 2026

(54) PLASMA ION SOURCE DEVICE WITH DIGITAL ENERGY-LEVEL CONTROL AND IONIZATION CONTROL METHOD

(71) Applicant: ZHEJIANG UNIVERSITY, Zhejiang (CN)

(72) Inventors: Xiaozhi WANG, Zhejiang (CN); Fengjian CHU, Zhejiang (CN); Yuanjiang PAN, Zhejiang (CN); Hongru FENG, Zhejiang (CN); Gaosheng ZHAO, Zhejiang (CN)

(73) Assignee: ZHEJIANG UNIVERSITY, Zhejiang (CN)

(21) Appl. No.: 19/650,230

(22) Filed: Apr. 16, 2026

Related U.S. Application Data
(63) Continuation of application No. PCT/CN2024/116301, filed on Sep. 2, 2024.

(30) Foreign Application Priority Data
Oct. 24, 2023 (CN) 202311382425.9

(51) Int. Cl. H01J 49/02; H01J 49/04; G01N 30/72

(52) U.S. Cl. CPC H01J 49/022; H01J 49/04; G01N 30/7233

(57) ABSTRACT

Disclosed are a plasma ion source device with digital energy-level control and an ionization control method. The plasma main module and the sample injector face the plasma beam region, the digital-controlled module is located beside the plasma main module and controls the plasma main module. The method feeds the configured solution or gas sample into the sample injector and then ejects gas-phase substances, the arbitrary waveform generator control panel inputs control waveform to the plasma torch tube to emit plasma to the plasma beam region, and the gas-phase substances collide with electrons/ions in the plasma to form gas-phase ions, which are then detected by a mass spectrometer.

### CROSS-REFERENCE TO RELATED APPLICATION

This application is a continuation of International Application No. PCT/CN2024/116301, filed on September 2, 2024, which claims priority to Chinese Patent Application No. 202311382425.9, filed on October 24, 2023. The disclosures of the aforementioned applications are hereby incorporated by reference in their entireties.

### BACKGROUND

### TECHNICAL FIELD

The present disclosure relates to an atmospheric pressure ionization mass spectrometer technology, and particularly relates to a plasma ion source with digital energy-level control and an ionization control method.

### RELATED ART

Ambient mass spectrometer (AMS) permits the ionization, at atmospheric pressure, of samples that are untreated or subject only to minimal modification. Over the past two decades, dozens of new AMS techniques and their variants have been developed, employing various modalities such as electrospray, laser ablation, plasma, thermal desorption, and vibrational excitation to directly detect a wide array of compounds. However, due to substantial differences in the chemical properties of analytes, no single AMS technique can readily encompass all sample types. For example, AMS techniques predicated on electrospray mechanisms are generally provided for nonvolatile, polar compounds across a broad mass range, whereas AMS techniques predicated on atmospheric-pressure chemical ionization (APCI) mechanisms are capable of characterizing nonpolar or weakly polar compounds.

To expand the range of detectable analyte molecules, researchers have integrated multiple ionization techniques into a single device, whereby, through parameter adjustment, both discrete and combined ionization modes may be obtained, thereby enabling the concurrent detection of polar and nonpolar compounds. Notwithstanding the foregoing, the integration and switching among disparate ionization techniques is often complex; accordingly, the development of AMS technologies affording flexibly and controllably adjustable ionization energy, so as to achieve coverage across a broad ionization range, constitutes a matter of significant concern to numerous analytical chemists.

### SUMMARY OF DISCLOSURE

To address the problems existing in the background art, the present disclosure provides a plasma ion source device with digital energy-level control and an ionization method under digitally-graded control. By driving the plasma power supply with an arbitrary waveform controller, digital regulation of plasma energy and power is achieved, implementing energy control through rapid digital functional waveforms. This substantially increases analytical throughput and accomplishes energy-dimension scanning ionization within a timescale on the order of seconds. When coupled for liquid chromatography-mass spectrometer (LC-MS) coupling, the disclosure fully resolves all different analytes within a single peak envelope, thereby overcoming the limitation in the coverage of detectable molecular species associated with commercial ion sources in LC-MS coupling, and achieving high-throughput, comprehensive analysis using atmospheric-pressure ion sources.

The technical solution of the present disclosure is as follows:

I. A plasma ion source device with digital energy-level control:

The device includes a plasma beam region, a sample injector, a plasma main module, a digital-controlled module, and a support adjustment module. The sample injector, the digital-controlled module, and the plasma main module are provided on the support adjustment module. The plasma main module and the sample injector are arranged facing the plasma beam region. The digital-controlled module is located beside the plasma main module. The digital-controlled module is electrically connected to the plasma main module through a signal transmission line and controls the plasma main module.

The support adjustment module includes a mass spectrometer connector, a base, a three-axis moving platform, and a plasma support panel. An end of an upper surface of the base is fixed with the mass spectrometer connector through a bolt. A side of the mass spectrometer connector is provided with an atmospheric pressure mass spectrometer inlet. The atmospheric pressure mass spectrometer inlet faces the plasma beam region. The atmospheric pressure mass spectrometer inlet is located directly above the base. The upper surface of the base is provided with the three-axis moving platform. The three-axis moving platform is fixedly connected with the plasma support panel on top. The plasma support panel is provided with the plasma main module and the sample injector through the bolt on top. The sample injector is horizontally movably provided on the plasma support panel through a slider bracket. The three-axis moving platform is provided for driving the plasma main module and the sample injector to perform three-dimensional movement. The slider bracket and the plasma support panel are locked through a two-slot structure. The slider bracket is able to slide along a slot direction to realize adjustment of front and rear positions, ensuring that an injection position of the sample injector provided on the slider bracket is appropriate, and a target compound is atomized into spray droplets or gas samples through the sample injector.

The plasma main module includes a plasma torch tube, a circuit interface, and a gas line interface. The plasma torch tube is electrically connected to the digital-controlled module. An end of the plasma torch tube is connected to an external plasma working gas source through the gas line interface. The gas line interface is provided for adding plasma working gas. The other end of the plasma torch tube is provided with a plasma beam outlet. The plasma beam outlet faces the plasma beam region. The plasma main module relies on microwave energy generated by the digital-controlled module for activation, and requires addition of argon gas for stabilization during operation. The plasma torch tube is connected to a digital-controlled power supply through the circuit interface.

The digital-controlled module includes an arbitrary waveform generator control panel and a microwave power supply box. The arbitrary waveform generator control panel is connected to the plasma torch tube through the signal transmission line. The microwave power supply box is electrically connected to the arbitrary waveform generator control panel through the signal transmission line. The arbitrary waveform generator control panel is provided for rapidly regulating plasma energy.

II. An ionization method under digitally-graded control for a plasma ion source device with digital energy-level control, including the following steps:
1) Configuring a chemical solution sample under test or a gas sample under test;
2) Connecting the plasma ion source device and a mass spectrometer, connecting and opening the circuit interface and the gas line interface, setting a control waveform energy through the arbitrary waveform generator control panel, generating a required waveform energy-level ionization energy range for a target analyte by the arbitrary waveform generator control panel, and selecting a corresponding waveform signal;
3) Opening the sample injector, and feeding the configured chemical solution sample or the gas sample into the sample injector;
4) Ejecting gas-phase substances by the sample injector, while inputting a control waveform to the plasma torch tube by the arbitrary waveform generator control panel, controlling a plasma main power of the plasma torch tube through the digital-controlled power supply, regulating the gas line, wherein the plasma torch tube activates plasma to irradiate the plasma from the plasma beam outlet to the plasma beam region, the gas-phase substances collide with electrons/ions in the plasma, a solvent is removed to form gas-phase ions; due to digitized power control, a scanned ionization energy produces differences, enabling samples of different forms to be fully charged;
5) Introducing the obtained gas-phase ions into the mass spectrometer through the atmospheric pressure mass spectrometer inlet for mass spectrometer detection.

In the step 4), the electrons/ions include metastable high-energy electrons, primary gas-phase ions, and high-energy positive ions.

In the step 3), when the chemical solution sample is fed to the sample injector, the chemical solution sample is atomized into spray droplets to serve as the gas-phase substances; when the gas sample is fed to the sample injector, the gas sample directly serves as the gas-phase substances.

In the step 1), the solvent of the solution includes one or a mixture of methanol, water, and acetonitrile.

In the step 2), the waveform energy-level set by the arbitrary waveform generator control panel realizes rapid adjustment of plasma energy from 100W to 200W within 0.5 seconds to 5 seconds.

In the step 4), when the chemical solution sample or the gas sample under test is a compound requiring soft ionization, the plasma main power of the plasma torch tube is adjusted to below 140W, and the compound requiring soft ionization includes peptides, pharmaceuticals, or amino acids.

When the chemical solution sample or the gas sample under test is a compound requiring hard ionization, the plasma main power of the plasma torch tube is adjusted to 140W to 160W, and the compound requiring hard ionization includes polycyclic aromatic hydrocarbons, halogenated hydrocarbons, or ferrocene.

When the chemical solution sample or the gas sample under test is a substance that requires high energy for desorption, the plasma main power of the plasma torch tube is adjusted to 160W to 200W, and the substances that require high energy for desorption include metal elements, inorganic lead, or inorganic mercury.

The sample injector may be connected to a liquid phase to realize digitized energy plasma liquid chromatography-mass spectrometer coupling.

In the step 5), a detection mode of an ion detector used in a mass-spectrometric analysis is a positive ion mode or a negative ion mode.

In the step 5), the detection of the ion detector used in the mass-spectrometric analysis includes ion trap, orbital trap or time-of-flight mass spectrometer, and a single scan time may not exceed 500ms.

The advantageous effects of the present disclosure are:

The present disclosure employs the arbitrary waveform controller to deliver and regulate the energy level of a plasma, providing flexible and controllable energy application. The present disclosure completes energy-dimension scanning ionization within a timescale on the order of seconds, thereby greatly increasing detection throughput. The present disclosure accelerates the matching of waveform scanning with the liquid-phase peak elution time and the mass spectrometric scan time. Moreover, in liquid chromatography-mass spectrometer (LC-MS) coupling, the present disclosure enables complete resolution of distinct analytes within a single peak envelope, thereby achieving coverage analysis over a wide ionization range.

The present disclosure possesses substantial innovativeness and practical utility and is applicable to mass-spectrometric analysis across a broad range of fields, including, without limitation, laboratory operations, industrial production, pharmaceutical research, and public security administration.

### BRIEF DESCRIPTION OF THE DRAWINGS

FIG. 1 is a schematic diagram of a plasma ion source device with digital energy-level control.

FIG. 2 is an energy diagram with a digitized triangular wave as an input control function.

FIG. 3 is a mass spectrum of L-tyrosine measured under digitized triangular wave energy control conditions.

FIG. 4 shows a perylene mass spectrum measured under digitized triangular wave energy control conditions.

FIG. 5 is a mass spectrum of divalent lead measured under digitized triangular wave energy control conditions.

FIG. 6 is an extracted ion chromatogram of divalent lead measured under digitized triangular wave energy control conditions.

FIG. 7 is an extracted ion chromatogram of perylene measured under digitized triangular wave energy control conditions.

FIG. 8 is an extracted ion chromatogram of L-tyrosine measured under digitized triangular wave energy control conditions.

FIG. 9 is a mass spectrum of divalent lead and reserpine measured under digitized rectangular energy rapid scan conditions.

FIG. 10 is an extracted ion chromatogram of two substances overlaid under 1Hz rectangular wave conditions.

FIG. 11 is an extracted ion chromatogram of two substances overlaid under 0.5Hz rectangular wave conditions.

FIG. 12 is an extracted ion chromatogram of two substances overlaid under 0.2Hz rectangular wave conditions.

FIG. 13 is an extracted ion chromatogram of two substances overlaid under 0.2Hz sawtooth wave conditions.

FIG. 14 is an extracted ion chromatogram of two substances overlaid under 0.2Hz triangular wave conditions.

FIG. 15 shows an extracted ion chromatogram for reserpine, perylene, L-Phe-L-Phe, cortisone, and triphenyltin hydride at different liquid-chromatographic retention times under LC coupling.

FIG. 16 shows an overlaid mass spectrum of spiked serum (including benzo[a]pyrene, anthracene, anilofos, sulpiride, midecamycin, prochlorperazine, triphenyltin chloride, reserpine, and divalent lead) obtained following energy-scan ionization.

FIG. 17 shows respective analytes (benzo[a]pyrene, anthracene, anilofos, sulpiride, midecamycin, reserpine, and divalent lead) attain their maximum signal responses at different positions along an energy ladder.

FIG. 18 shows an extracted ion chromatogram for serum samples analyzed by the method in conjunction with LC coupling, wherein multiple energy scans are performed within a single liquid chromatographic peak. The inset provides an enlarged view of the extracted ion chromatogram in the vicinity of 1.6 minutes to 3.0 minutes corresponding to anilofos.

### DESCRIPTION OF THE EMBODIMENTS

To facilitate understanding of the present disclosure, the present disclosure will be described more comprehensively and in detail below in conjunction with the accompanying drawings and preferred embodiments, but the protection scope of the present disclosure is not limited to the following specific embodiments.

Unless otherwise defined, all technical terms used herein have the same meaning as commonly understood by one of ordinary skill in the art. The technical terms used herein are only for the purpose of describing specific embodiments and are not intended to limit the protection scope of the present disclosure.

In the description of the present disclosure, it should be noted that the terms "upper", "lower", "left", "right", "inner", "outer", "middle", "vertical", "horizontal" and other indications of orientation or positional relationship are based on the orientation or positional relationship shown in the drawings, and are only for the convenience of describing the disclosure and simplifying the description, rather than indicating or implying that the referenced device or component must have a specific orientation, be constructed and operated in a specific orientation, and therefore should not be understood as limitations on the disclosure.

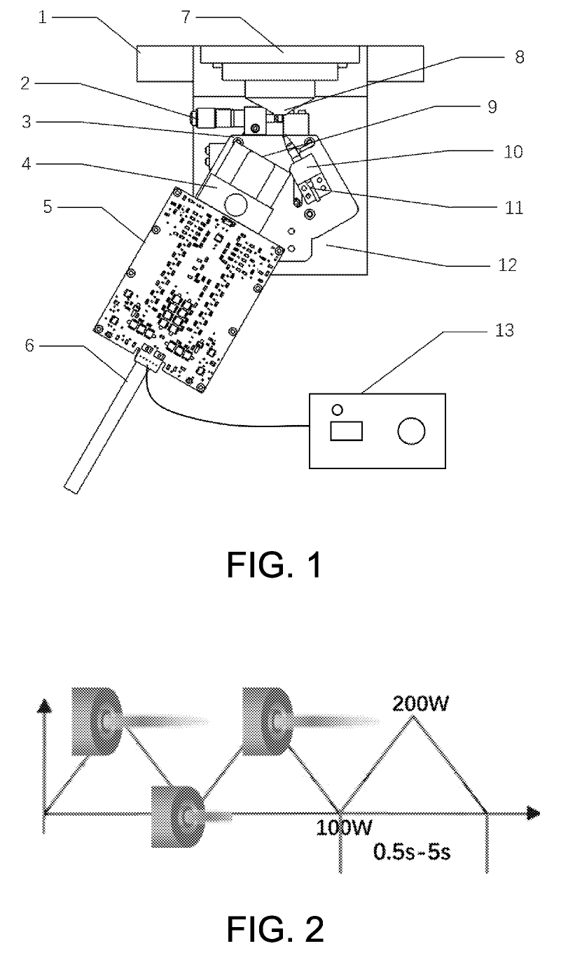

As shown in FIG. 1, a device includes a plasma beam region, a sample injector 11, a plasma main module, a digital-controlled module, and a support adjustment module 1. The sample injector 11, the digital-controlled module, and the plasma main module are provided on the support adjustment module 1. The plasma main module and the sample injector 11 are arranged facing the plasma beam region. The digital-controlled module is located beside the plasma main module. The digital-controlled module is electrically connected to the plasma main module through a signal transmission line and controls the plasma main module.

The support adjustment module 1 includes a mass spectrometer connector 7, a base 12, a three-axis moving platform 2, and a plasma support panel 3. An end of an upper surface of the base 12 is fixed with the mass spectrometer connector 7 through a bolt. A side of the mass spectrometer connector 7 is provided with an atmospheric pressure mass spectrometer inlet 8. The atmospheric pressure mass spectrometer inlet 8 faces the plasma beam region. The atmospheric pressure mass spectrometer inlet 8 is located directly above the base 12. The upper surface of the base 12 is provided with the three-axis moving platform 2. The three-axis moving platform 2 is fixedly connected with the plasma support panel 3 on top. The plasma support panel 3 is provided with the plasma main module and the sample injector 11 through the bolt on top. The sample injector 11 is horizontally movably provided on the plasma support panel 3 through a slider bracket 10. The slider bracket 10 and the plasma support panel 3 are locked through a two-slot structure. The slider bracket 10 is able to slide along a slot direction to realize adjustment of front and rear positions, ensuring that an injection position of the sample injector 11 provided on the slider bracket 10 is appropriate, and a target compound is atomized into spray droplets or gas samples through the sample injector 11.

The plasma main module includes a plasma torch tube 4, a circuit interface, and a gas line interface 6. The plasma torch tube 4 is electrically connected to the digital-controlled module. An end of the plasma torch tube 4 is connected to an external plasma working gas source through the gas line interface 6. The gas line interface 6 is provided for adding plasma working gas. The other end of the plasma torch tube 4 is provided with a plasma beam outlet 9. The plasma beam outlet 9 faces the plasma beam region. The plasma main module relies on microwave energy generated by the digital-controlled module for activation, and requires addition of argon gas for stabilization during operation. The plasma torch tube 4 is connected to a digital-controlled power supply through the circuit interface.

The digital-controlled module includes an arbitrary waveform generator control panel 5 and a microwave power supply box 13. The arbitrary waveform generator control panel 5 is connected to the plasma torch tube 4 through the signal transmission line. The microwave power supply box 13 is electrically connected to the arbitrary waveform generator control panel 5 through the signal transmission line. The arbitrary waveform generator control panel 5 is provided for rapidly regulating plasma energy.

The sample injector may be implemented using a nebulizer, a gas delivery tube, etc. In the embodiment, a nebulizer is adopted, and by adding an adapter interface to the sample injector 11, the device may be directly coupled to a liquid phase.

The gas line interface 6 is connected to the external plasma working gas source, and the plasma working gas in the embodiment is argon gas.

The arbitrary waveform generator control panel 5 generates arbitrary waveform signals for rapid control of plasma energy. The arbitrary waveforms include sawtooth waves, sine waves, rectangular waves, or triangular waves, with a frequency range of 0.1Hz to 5Hz. A voltage amplitude is determined by the microwave power supply box, and an overall output power may be precisely digital-controlled within a range of 100W to 200W.

There are no explicit requirements for the liquid chromatography and mass spectrometer systems compatible with the device. The only requirement for the mass spectrometer is that its ion source be replaceable; acceptable types include ion trap, time-of-flight (TOF), Orbitrap, and magnetic sector mass spectrometers. Reasonable efforts shall be made to ensure that a single-scan acquisition time of the mass spectrometer is less than 500 milliseconds.

The specific operation process is as follows:
1) Configuring a chemical solution sample under test or a gas sample under test;
2) Connecting the plasma ion source device and a mass spectrometer, connecting and opening the circuit interface and the gas line interface 6, setting a control waveform energy through the arbitrary waveform generator control panel 5, generating a required waveform energy-level ionization energy range for a target analyte by the arbitrary waveform generator control panel 5, and selecting a corresponding waveform signal;
3) Opening the sample injector 11, and feeding the configured chemical solution sample or the gas sample into the sample injector 11;
4) Ejecting gas-phase substances by the sample injector 11, while inputting a control waveform to the plasma torch tube 4 by the arbitrary waveform generator control panel 5, controlling a plasma main power of the plasma torch tube 4 through the digital-controlled power supply, regulating the gas line, wherein the plasma torch tube 4 activates plasma to irradiate the plasma from the plasma beam outlet 9 to the plasma beam region, the gas-phase substances collide with electrons/ions in the plasma, a solvent is removed to form gas-phase ions; due to digitized power control, a scanned ionization energy produces differences, enabling samples of different forms to be fully charged;
5) Introducing the obtained gas-phase ions into the mass spectrometer through the atmospheric pressure mass spectrometer inlet 8 for mass spectrometer detection.

In the step 4), the electrons/ions include metastable high-energy electrons, primary gas-phase ions, and high-energy positive ions.

In the step 3), when the chemical solution sample is fed to the sample injector 11, the chemical solution sample is atomized into spray droplets to serve as the gas-phase substances; when the gas sample is fed to the sample injector 11, the gas sample directly serves as the gas-phase substances.

In the step 1), the solvent of the solution includes one or a mixture of methanol, water, and acetonitrile.

In the step 2), the waveform energy-level set by the arbitrary waveform generator control panel 5 realizes rapid adjustment of plasma energy from 100W to 200W within 0.5 seconds to 5 seconds.

In the step 4), when the chemical solution sample or the gas sample under test is a compound requiring soft ionization, the plasma main power of the plasma torch tube 4 is adjusted to below 140W, and the compound requiring soft ionization includes peptides, pharmaceuticals, or amino acids.

When the chemical solution sample or the gas sample under test is a compound requiring hard ionization, the plasma main power of the plasma torch tube 4 is adjusted to 140W to 160W, and the compound requiring hard ionization includes polycyclic aromatic hydrocarbons, halogenated hydrocarbons, or ferrocene.

When the chemical solution sample or the gas sample under test is a substance that requires high energy for desorption, the plasma main power of the plasma torch tube 4 is adjusted to 160W to 200W, and the substances that require high energy for desorption include metal elements, inorganic lead, or inorganic mercury.

To make the objectives, technical solutions, and advantages of the present disclosure clearer, the present disclosure will be described in further detail below in conjunction with embodiments.

Embodiments of the present disclosure are as follows:

### Example 1:

The plasma ion source device with digital energy-level control designed in accordance with the present disclosure, together with an Ultimate UPLC/LTQ Orbitrap mass spectrometer (Thermo Fisher Scientific, USA; hereinafter, “Thermo Fisher”), were employed to test small-molecule analytes in a solvent, namely L-tyrosine (mass number 182), polycyclic aromatic hydrocarbon perylene (mass number 252), and a divalent lead element (mass number 208).

### 1. Experimental Materials

L-tyrosine, perylene, and lead chloride reference standards (analytical grade; supplied by Shanghai Naicheng Biotechnology Co., Ltd.; the same applies hereinafter) were properly stored under refrigeration for experimental use. During the experimental procedure, samples in the corresponding masses were weighed. Acetonitrile and water (1:1) were used as the solvent. The mixture was subjected to ultrasonication for 5 minutes. Mixed standard solutions of identical concentration (10mg/L) were prepared, and the solutions were thereafter subjected to ultrasonication for an additional 5 minutes.

### 2. Experimental Parameters

Sample injection conditions: Acetonitrile and water (1:1), a flow rate of 0.1mL/min.

Digital-controlled module: A triangular wave with a frequency of 0.2Hz to 2Hz was adopted as an input control function, with an energy amplitude of 100W and an energy offset of 150W, thereby generating a plasma beam with an energy scan of 100W to 200W, as shown in FIG. 2.

Sample injector: A concentric nebulizer was adopted; Nebulizing gas: Organic solvent spray module with a flow rate: 3L/min; Sample spray generation module with a flow rate: 3L/min.

Mass spectrometer conditions: Positive ion detection mode; a scanning method is performed via positive ion full scan.

Ion source parameters: Ion transfer tube: 300°C; Ion transfer tube with a voltage: 30V; Lens with a voltage: 100V.

### 3. Experimental Results

Each of the three compounds tested may be successfully detected during digital-controlled plasma energy scanning, and the energy range of the present disclosure enables soft ionization, hard ionization, and rapid scanning of ions of metal elements.

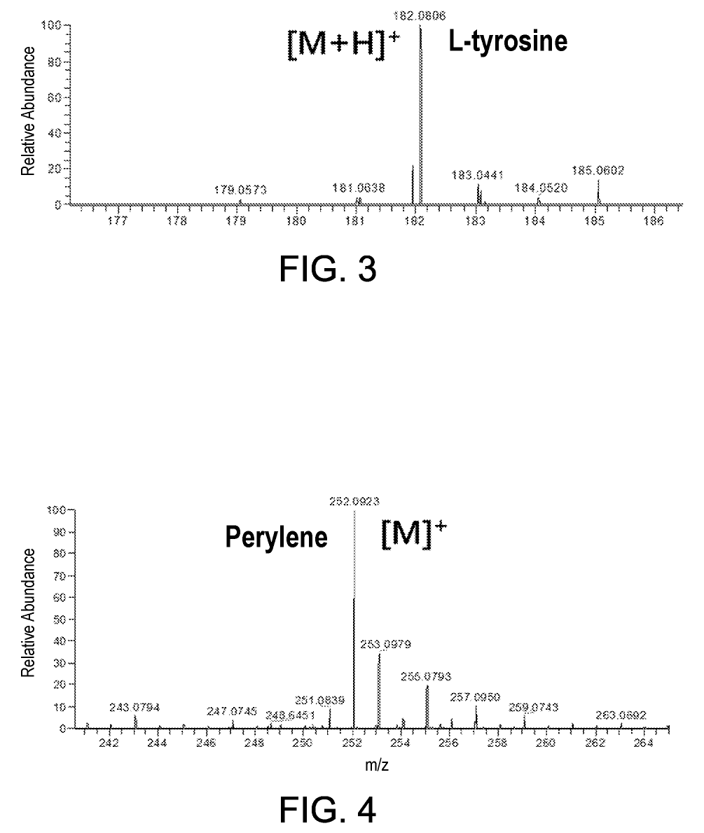

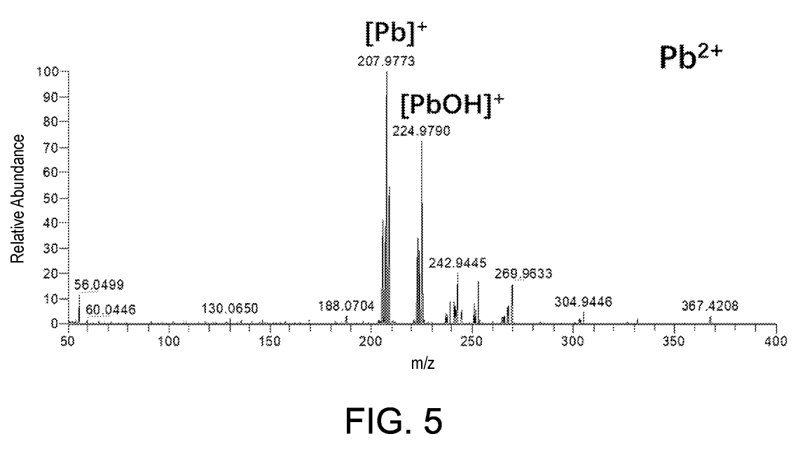

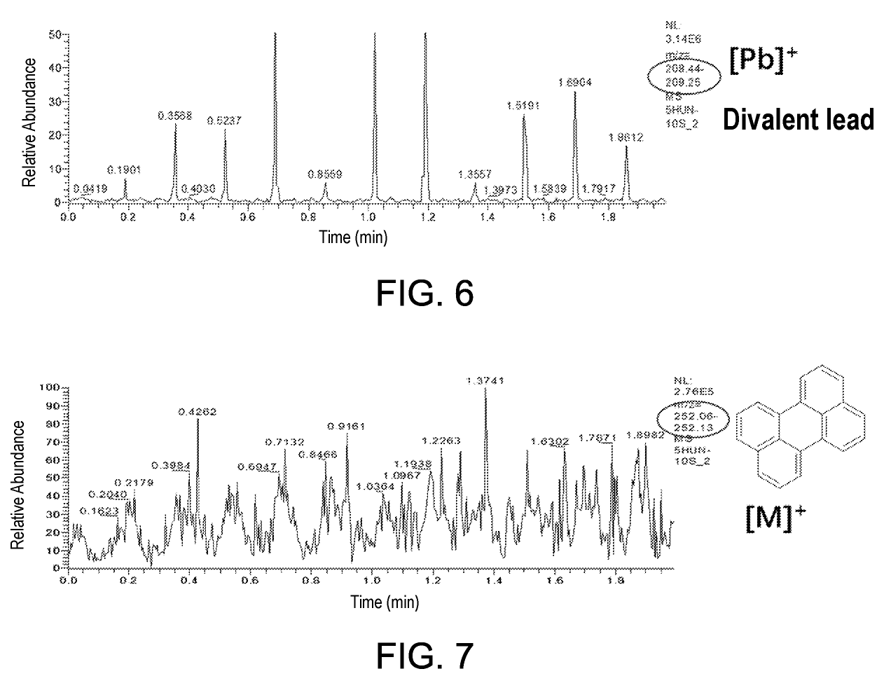

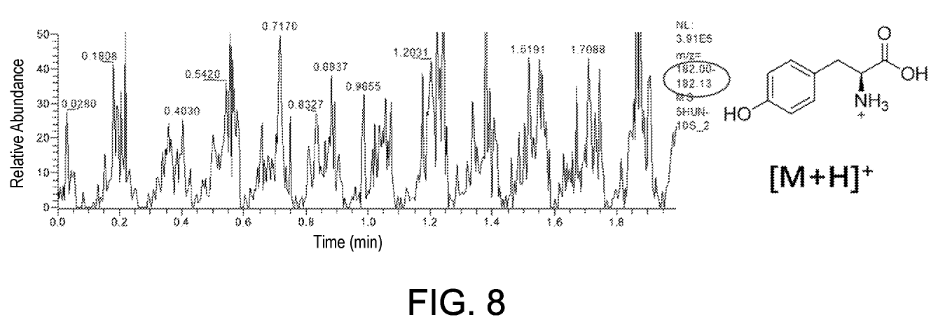

As depicted in FIG. 3 through FIG. 5, L-tyrosine appears as a protonated ion, perylene presents a molecular ion peak, and lead chloride yields an elemental lead peak. The entire spectrum was scanned within 0.5 seconds to 5 seconds, thereby substantiating the reasonableness of regulating ionization energy through the digital-controlled energy mode employed by this method. Thereafter, extracted ion currents were generated for the foregoing three ions. As shown in FIG. 6 through FIG. 8, the maximum ion signal intensities of the three ions differ significantly. Metal elements require the highest ionization energy to achieve desorption; accordingly, the ion current for lead exhibits a relatively sharp peak, appearing only when the applied energy attains its maximum. As a nonpolar compound, perylene undergoes ionization predominantly via electron-impact processes; consequently, the plasma energy required therefor is higher than that for amino acids and lower than that for lead ions. By contrast, L-tyrosine ionizes on the basis of proton affinity and undergoes soft ionization at lower energies, producing a protonated ion peak. The respective ionization thresholds for these three types of compounds are approximately 140W, 160W, and 200W. On this basis, three energy tiers are defined: soft-ionization mode, 100W to 140W; hard-ionization mode, 140W to 180W; and elemental analysis mode (high-energy mode), 180W to 200W.

### Example 2:

To demonstrate that the energy range of the present disclosure may realize soft ionization and rapid scanning of metal element ions, the plasma ion source device with digital energy-level control designed by the present disclosure is utilized to set energy waveforms with different scanning frequencies, combined with ultimate UPLC/LTQ Orbitrap mass spectrometer to test reserpine (mass number 609), divalent lead element (mass number 208), perylene (mass number 252), L-Phe-L-Phe (mass number 313), cortisone (mass number 361), and triphenyltin hydride (mass number 351) in the solvent.

### 1. Experimental Materials

Reserpine, lead chloride, perylene, L-Phe-L-Phe, cortisone, and triphenyltin hydride reference standards (analytical grade; supplied by Shanghai Naicheng Biotechnology Co., Ltd.; the same applies hereinafter) were properly stored under refrigeration for experimental use. During the experimental procedure, samples in the corresponding masses were weighed. Methanol and water (1:1) were used as the solvent. The mixture was subjected to ultrasonication for 5 minutes. Mixed standard solutions of identical concentration (10mg/L) were prepared, and the solutions were thereafter subjected to ultrasonication for an additional 5 minutes.

### 2. Experimental Parameters

Sample injection conditions: Methanol and water (1:1), a flow rate of 0.1mL/min.

Digital-controlled module: A rectangular wave with a frequency of 0.2Hz to 2Hz and a triangular wave with the same frequency as well as a sawtooth wave were adopted as input control functions, with an energy amplitude of 100W and an energy offset of 150W, thereby generating a plasma beam with an energy scan of 100W to 200W.

Sample injector: A concentric nebulizer was adopted; Nebulizing gas: Organic solvent spray module with a flow rate: 3L/min; Sample spray generation module with a flow rate: 3L/min.

Mass spectrometer conditions: Positive ion detection mode; a scanning method is performed via positive ion full scan.

Ion source parameters: Ion transfer tube: 300°C; Ion transfer tube with a voltage: 30V; Lens with a voltage: 100V.

### 3. Experimental Results

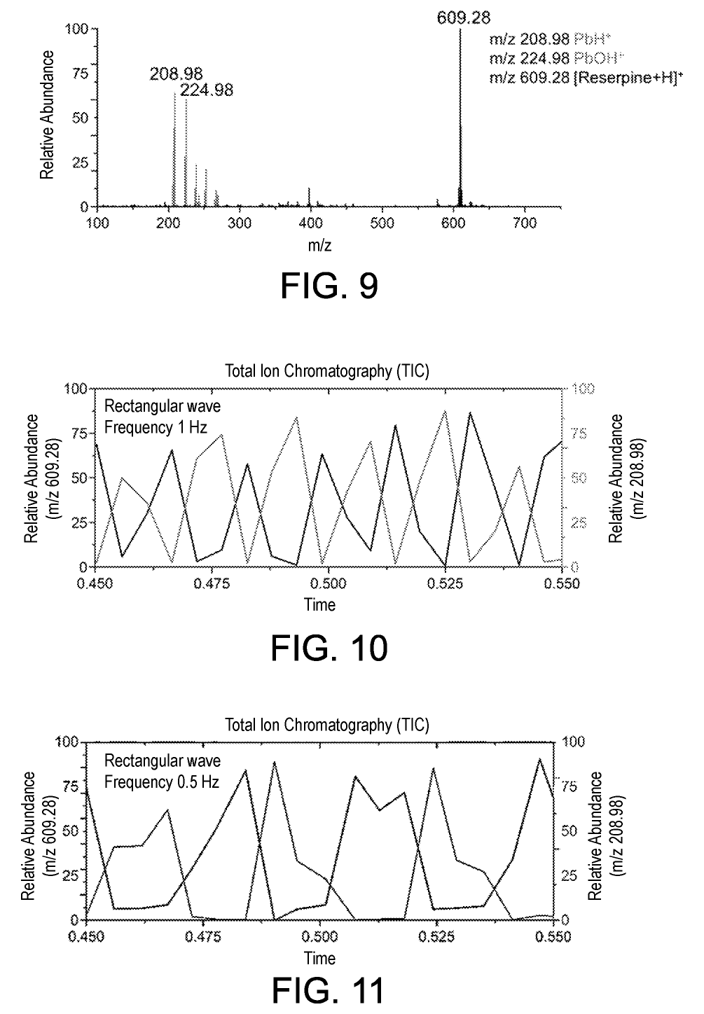

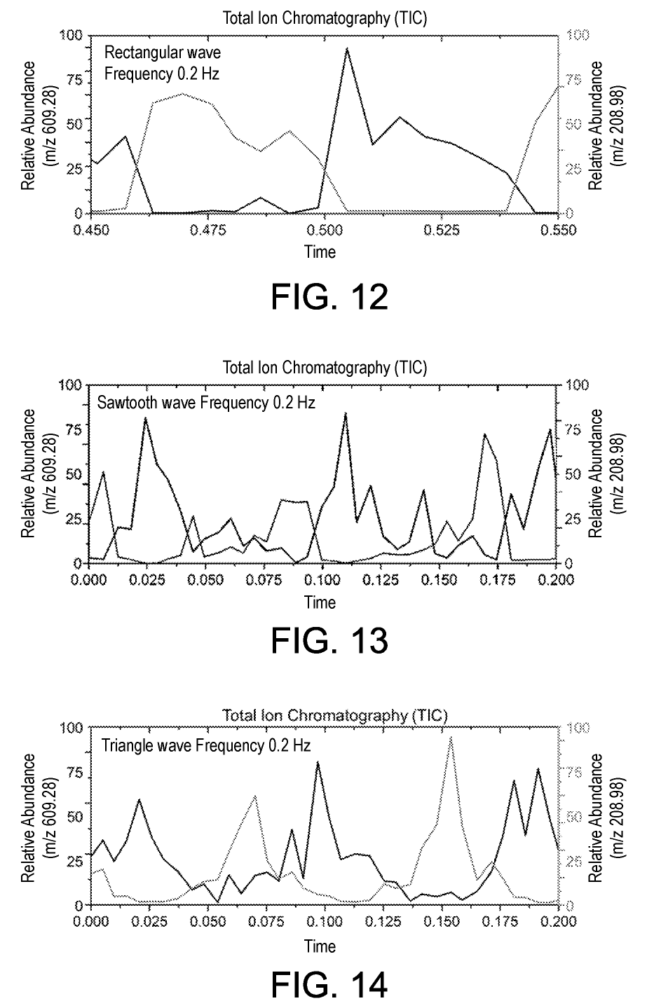

First, the efficacy of rapid scanning using digital-controlled waveforms was verified, as illustrated in FIG. 9. FIG. 9 constitutes an overlaid mass spectrum of the metal element lead (m/z 208.98) and reserpine (m/z 609.28). It is evident that both target analytes yield high ion signal intensities. FIG. 10 sets forth the overlaid extracted ion chromatogram of the two substances under a 1Hz square-wave condition. Within a scan time on the order of seconds, the two compounds exhibit sequential peaks in accordance with the level of scanning energy, producing offset line plots and thereby corroborating the functionality of rapid energy scanning. Thereafter, the impact of differing operating frequencies on the results was verified. FIG. 11 presents the overlaid extracted ion chromatogram of the two substances under a 0.5Hz rectangular-wave condition, and FIG. 12 presents the overlaid extracted ion chromatogram under a 0.2Hz rectangular-wave condition. Stable ion current intensities are still obtained within 1 second, demonstrating that the rapid scan may attain an actual scan period of less than 0.5 seconds and fully satisfies the time-resolved analytical requirements of LC-MS coupling. Subsequently, ionization energy was manipulated by employing different types of control waveforms. FIG. 13 provides the overlaid extracted ion chromatogram of the two substances under a 0.2Hz triangular-wave condition, and FIG. 14 provides the overlaid extracted ion chromatogram under a 0.2Hz sawtooth-wave condition, with the results exhibiting corresponding distinctions.

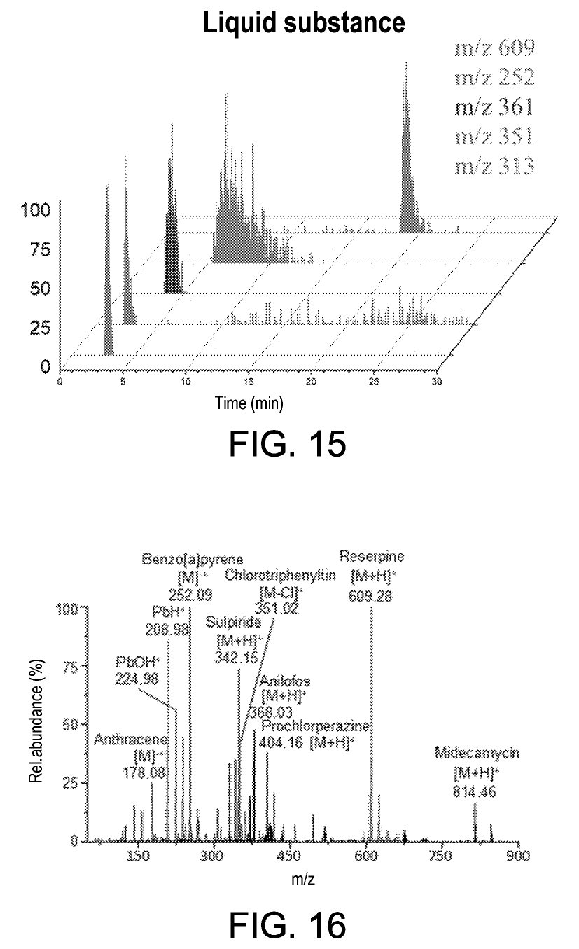

Subsequently, the liquid chromatography-mass spectrometry (LC-MS) analysis was conducted on the sample. FIG. 15 presents the extracted ion chromatogram, under liquid-phase coupling, for reserpine, perylene, L-Phe-L-Phe, cortisone, and triphenyltin hydride at different liquid-phase retention times. Within a single liquid chromatographic peak envelope, approximately ten rapid ionization-energy scans may be completed, which manifest in the liquid-phase extracted ion chromatograms as densely clustered peak envelopes, thereby sufficiently demonstrating the practical effectiveness of the digital-controlled ionization-energy scanning method.

### Example 3:

To evaluate the applicability of the methods described in the present disclosure to actual samples, the plasma ion source device with digital energy-level control, as designed in the present disclosure, was employed in combination with an UltiMate UPLC/LTQ Orbitrap mass spectrometer (Thermo Fisher Scientific, USA; hereinafter the same) to analyze nine toxicological analytes in serum. The analytes included pesticides (anilofos), polycyclic aromatic hydrocarbons (anthracene and benzo[a]pyrene), inorganic heavy-metal compounds (lead chloride), organometallic compounds (triphenyltin chloride), and psychoactive and conventional pharmaceuticals (sulpiride, midecamycin, prochlorperazine, and reserpine).

### 1. Experimental Materials

Anilofos, anthracene, benzo[a]pyrene, lead chloride, triphenyltin chloride, sulpiride, midecamycin, prochlorperazine, and a reserpine reference standard (analytical grade) were kept under refrigeration and appropriately preserved for experimental use. Chicken serum was procured from Genom Bio Co. (Hangzhou, China), and the preparation method is set forth as follows. 200μL of chicken serum were combined with 10μL of a mixture of the nine standards (1mg mL⁻¹), followed by the addition of 800µL of acetonitrile to precipitate proteins. The solution was then subjected to ultrasonication for 5 minutes, centrifuged at 4193×g for 3 minutes, allowed to precipitate at 4°C for 10 minutes, the supernatant was filtered, and the filtrate was stored at -20°C pending use. The spiked concentration of the test serum extract was 10mg L⁻¹. Blank serum was processed in the same manner. Quantification was conducted using a concentration range of 0.0mg L⁻¹ to 5mg L⁻¹.

### 2. Experimental Parameters

Sample injection conditions: Acetonitrile and water (1:1), a flow rate of 0.4mL/min.

Digital-controlled module: A custom-programmed stepped waveform was employed as an input control function, with an initial energy set at 100W and increased in increments of 20W to reach 200W within 2 seconds, thereafter repeating cyclically, thereby generating a plasma beam with an energy scan from 100W to 200W.

Sample injector: A concentric nebulizer was adopted; Nebulizer with a flow rate: 3L/min.

Mass spectrometer conditions: Positive ion detection mode; a scanning method is performed via positive ion full scan.

Liquid chromatography conditions: The liquid chromatograph was the Thermo Fisher UltiMate 3000 UPLC. A chromatographic column was a HYPERSIL GOLD C18 column (2.1mm × 100mm, 3.0μm). Gradient elution was conducted using a mobile phase A (a 1‰ aqueous solution of formic acid) and a mobile phase B (acetonitrile). The flow rate was 0.4 mL/min. The injection volume was 3μL. A column temperature was 30°C. Gradient elution: 1μL min⁻¹; 30°C. The elution gradient program was as follows: at 0.0 min, 10% B (10% acetonitrile aqueous solution); from 0.0 to 20.0 min, 10% to 100% B; from 20.0 to 30.0 min, 100% B; from 30.0 to 31.0 min, 100% to 10% B; from 31.0 to 35.0 min, 10% B.

Ion source parameters: Ion transfer tube: 300°C; Ion transfer tube with a voltage: 30V; Lens with a voltage: 100V.

### 3. Experimental Results

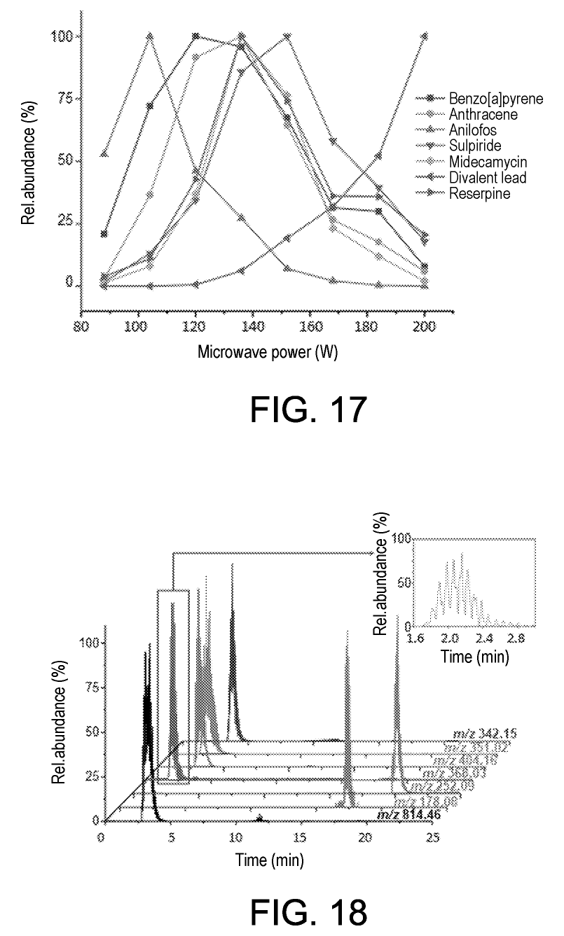

All nine compounds tested were successfully detected during digital-controlled plasma-energy scanning; accordingly, a stepped-waveform scanning mode at 100W to 200W may be employed to directly ionize these nine compounds, which exhibit disparate physicochemical properties, as illustrated in FIG. 16. During this scanning process, the analytes respectively reach their optimal energy positions; therefore, each compound exhibits its highest signal response at a particular energy step during the scan (FIG. 17). In other practical applications, the energy-scanning range may be adjusted in accordance with the characteristics of the sample. Direct quantitation of these nine analytes in serum using the digital scanning ionization technique exhibited favorable coefficients of determination (R²) (0.9355-0.9996) over a linear range of 10μg L⁻¹ to 5000μg L⁻¹. The limits of detection (LOD) and limits of quantitation (LOQ) were 0.88μg L⁻¹ to 14.49μg L⁻¹ and 2.94μg L⁻¹ to 48.31μg L⁻¹, respectively. Moreover, because the scanning time described in the present disclosure is between 0.5 seconds and 5 seconds, the device may be rapidly coupled with liquid chromatography to ensure that compounds within liquid-chromatographic peaks are highly ionized. Within the retention time of an analyte peak, the method may complete multiple energy-scanning cycles, generating dense minor peaks in the extracted ion chromatogram (EIC) (FIG. 18). Quantitative analysis may then be performed by fitting the apex of each peak and calculating the area.

Accordingly, the present disclosure provides a plasma ion source with digital energy-level control and an ionization method under digitally graded-control, which, by digitally regulating the control input of the plasma ion source, establishes a rapid ionization-energy scanning mode. The effect thereof enables high-coverage ionization energies sufficient to ionize analytes ranging from pharmaceutical molecules to metal elements. The analysis time for an entire single scan may be shortened to within 0.5 s. Compared with other ionization modalities, there is presently no ion source capable of simultaneously and rapidly performing soft ionization and metal element analysis, evidencing substantial innovativeness. Moreover, the method may be directly coupled with liquid chromatography under ambient pressure, fully matching the single-peak retention time of the liquid phase and being fully matched in order of magnitude with the liquid-phase elution time and the mass-spectrometric scan time. Therefore, the method provided by the present disclosure possesses strong innovativeness and practical value, and is applicable to mass-spectrometric analysis across various fields, including laboratory operations, industrial production, pharmaceutical research, and public security management.

The foregoing constitutes a further detailed description of the present disclosure in conjunction with specific preferred embodiments and shall not be construed as limiting the present disclosure to the embodiments described herein. It will be understood by those of ordinary skill in the art pertinent to the present disclosure that various simple derivations or substitutions may be made without departing from the spirit and scope of the present disclosure, and all such modifications shall be deemed to fall within the scope of protection of the present disclosure.

What is claimed is:

1. A plasma ion source device with digital energy-level control,
comprising a plasma beam region, a sample injector, a plasma main module, a digital-controlled module, and a support adjustment module, wherein the sample injector, the digital-controlled module, and the plasma main module are provided on the support adjustment module, the plasma main module and the sample injector are arranged facing the plasma beam region, the digital-controlled module is located beside the plasma main module, the digital-controlled module is electrically connected to the plasma main module through a signal transmission line and controls the plasma main module,
wherein the digital-controlled module comprises an arbitrary waveform generator control panel and a microwave power supply box, the arbitrary waveform generator control panel is connected to the plasma torch tube through the signal transmission line, the microwave power supply box is electrically connected to the arbitrary waveform generator control panel through the signal transmission line.

2. The plasma ion source device with digital energy-level control according to claim 1, wherein the support adjustment module comprises a mass spectrometer connector, a base, a three-axis moving platform, and a plasma support panel, an end of an upper surface of the base is fixed with the mass spectrometer connector, a side of the mass spectrometer connector is provided with an atmospheric pressure mass spectrometer inlet, the atmospheric pressure mass spectrometer inlet faces the plasma beam region, the atmospheric pressure mass spectrometer inlet is located directly above the base, the upper surface of the base is provided with the three-axis moving platform, the three-axis moving platform is fixedly connected with the plasma support panel on top, the plasma support panel is provided with the plasma main module and the sample injector on top, the sample injector is horizontally movably provided on the plasma support panel through a slider bracket.

3. The plasma ion source device with digital energy-level control according to claim 1, wherein the plasma main module comprises a plasma torch tube, a circuit interface, and a gas line interface, the plasma torch tube is electrically connected to the digital-controlled module, an end of the plasma torch tube is connected to an external plasma working gas source through the gas line interface, the other end of the plasma torch tube is provided with a plasma beam outlet, the plasma beam outlet faces the plasma beam region, the plasma torch tube is connected to a digital-controlled power supply through the circuit interface.

4. An ionization method under digitally-graded control for the device according to claim 1, comprising the following steps:
1) configuring a chemical solution sample under test or a gas sample under test;
2) connecting the plasma ion source device and a mass spectrometer, setting a control waveform energy through the arbitrary waveform generator control panel;
3) opening the sample injector, and feeding the configured chemical solution sample or the gas sample into the sample injector;
4) ejecting gas-phase substances by the sample injector, while inputting a control waveform to the plasma torch tube by the arbitrary waveform generator control panel, controlling a plasma main power of the plasma torch tube through the digital-controlled power supply, regulating the gas line, wherein the plasma torch tube activates plasma to irradiate the plasma from a plasma beam outlet to the plasma beam region, the gas-phase substances collide with electrons/ions in the plasma, a solvent is removed to form gas-phase ions;
5) introducing the obtained gas-phase ions into the mass spectrometer through the atmospheric pressure mass spectrometer inlet for mass spectrometer detection.

5. The ionization method under digitally-graded control according to claim 4, wherein:
in the step 4), the electrons/ions comprise metastable high-energy electrons, primary gas-phase ions, and high-energy positive ions.

6. The ionization method under digitally-graded control according to claim 4, wherein in the step 3), when the chemical solution sample is fed to the sample injector, the chemical solution sample is atomized into spray droplets to serve as the gas-phase substances, when the gas sample is fed to the sample injector, the gas sample directly serves as the gas-phase substances.

7. The ionization method under digitally-graded control according to claim 4, wherein in the step 1), the solvent of the solution comprises one or a mixture of methanol, water, and acetonitrile.

8. The ionization method under digitally-graded control according to claim 4, wherein in the step 2), the waveform energy-level set by the arbitrary waveform generator control panel realizes rapid adjustment of plasma energy from 100W to 200W within 0.5 seconds to 5 seconds.

9. The ionization method under digitally-graded control according to claim 4, wherein in the step 4), when the chemical solution sample or the gas sample under test is a compound requiring soft ionization, the plasma main power of the plasma torch tube is adjusted to below 140W, and the compound requiring soft ionization comprises peptides, pharmaceuticals, or amino acids;
when the chemical solution sample or the gas sample under test is a compound requiring hard ionization, the plasma main power of the plasma torch tube is adjusted to 140W to 160W, and the compound requiring hard ionization comprises polycyclic aromatic hydrocarbons, halogenated hydrocarbons, or ferrocene;
when the chemical solution sample or the gas sample under test is a substance that requires high energy for desorption, the plasma main power of the plasma torch tube is adjusted to 160W to 200W, and the sample comprises metal elements, inorganic lead, or inorganic mercury.
